(19) United States
(12) Patent Application Publication
(10) Pub. No.: US 2026/0249134 A1
(43) Pub. Date: Aug. 27, 2026

(54) SYSTEM AND METHOD FOR RECORDING AND WAGERING

(71) Applicant: Brent William SCHULDHAUS, Calgary (CA)

(72) Inventor: Brent William SCHULDHAUS, Calgary (CA)

(21) Appl. No.: 18/871,101

(22) PCT Filed: Jun. 5, 2023
(86) PCT No.: PCT/CA2023/050764

§ 371 Date: Dec. 2, 2024

Related U.S. Application Data
(60) Provisional application No. 63/348,587, filed on Jun. 3, 2022.

(51) Int. Cl. A63B 24/00; A63B 57/30; G06Q 50/34; G07F 17/32; H04W 4/021

(52) U.S. Cl. CPC A63B 24/0021; A63B 57/357; G06Q 50/34; G07F 17/3225; G07F 17/3244; G07F 17/3288; H04W 4/021; A63B 2024/0028; A63B 2220/12; A63B 2220/806; A63B 2225/20; A63B 2225/50

(57) ABSTRACT

There is provided a system and method for recording and wagering on sporting activities, including but not limited to golf. A smart flagstick device or other electronic devices may allow for video recordings of golf shots to be obtained in order to verify the outcome of the golf shot. A user may place a wager using an online wagering system, and obtain a reward if their golf shot satisfies the requisite condition (e.g. a hole in one, the shot closest to the pin among a plurality of shots).

### CROSS-REFERENCE TO RELATED APPLICATIONS

This claims the benefit of U.S. Provisional Patent Application No. 63/348,587, filed on Jun. 3, 2022, the entire contents of which are incorporated herein by reference.

### FIELD

This relates generally to computerized systems for recording activities, and in particular to systems for recording and wagering on activities.

### BACKGROUND

Wagering and betting activities are known to increase interest and engagement in various activities. For example, having a wager dependent upon the outcome of a sporting event may result in increased interest in watching or otherwise participating in that sporting event in some shape or form.

Various forms of online and virtual wagering are proliferating, particularly as laws in various jurisdictions surrounding wagering activities become more relaxed. However, such online wagering activities most commonly relate to either virtual games, or games in which the better is not an active participant.

Accordingly, there is a need for a robust solution to live wagering on activities in which the betting party is participating in the activity.

### SUMMARY

According to an aspect, there is provided a system for recording a golf activity, the system comprising: a flagstick device placed in a golf hole; a mobile device associated with a golfer; said system configured to: receive a wager from said mobile device relating to said golf hole; activating one or more cameras; recording a video with said cameras of an area in a vicinity of said golf hole; determining whether a ball is inside said golf hole.

According to another aspect, there is provided a method for recording a golf activity, the method comprising: receiving, from a mobile device, a wager relating to a golf hole; responsive to receiving said wager, activating one or more cameras; recording a video with said one or more cameras of an area in a vicinity of said golf hole; and detecting whether a ball is inside said golf hole.

Other features will become apparent from the drawings in conjunction with the following description.

### BRIEF DESCRIPTION OF DRAWINGS

In the figures which illustrate example embodiments,

FIG. 1 is a block diagram depicting components of an example computing system;

FIG. 2 is a block diagram depicting components of an example server, mobile device, or client computing device;

FIG. 3 is a block diagram depicting components of an example flagstick device;

FIG. 4 is a flow chart depicting an example method of recording an activity; and

FIG. 5 is an illustration of an example embodiment of a smart flagstick device.

### DETAILED DESCRIPTION

Although this disclosure places particular emphasis on golf, it will be appreciated that principles and systems described herein may have application with other activities, including other sporting activities.

Wagering on an activity such as golf typically occurs informally. For example, a group of golfers (typically 4 people or fewer), or possibly a larger group participating in an event, may agree to wager on an event. For example, it is typical at charity or organizational golf events (sometimes referred to as “golf days”) to include contests such as “closest to the pin” and “longest drive” contests.

In a “closest to the pin” contest, a hole (normally a par 3, in which only a tee shot is typically required to reach the green) is designated and participants will take tee shots. Normally, an indicator is placed on the green which designates the location of the tee shot which has landed the closest to the pin. When subsequent golfers come along, they may move the indicator to reflect the location of a closer shot to the pin/flagstick. At the end of the day, the golfer who produced the closest shot to the pin on the hole may receive a prize. Various foursomes or other groups may take part, but such systems typically rely on an “honour system”. That is, there is typically no objective verification of a participant's tee shot aside from other golfers in that group witnessing the shot.

Likewise, a “longest drive” contest may designate a hole (normally a par 4 or par 5 with a relatively straight fairway) and participants will take tee shots. The tee shot which lands the furthest from the tee box (while also landing within the confines of the fairway) will be designated the winner. Many groups may participate, by leaving an indicator on the fairway at the resting location of the tee shot. If a subsequent golfer hits their tee shot further, the indicator may then be moved to reflect an updated location.

Such traditional golf wagering games suffer from numerous drawbacks. For example, there is an opportunity for a dishonest golfer or group of golfers to simply cheat to win such a contest (e.g. by lying about the location of their tee shot, or attempting multiple tee shots (sometimes called mulligans) until one of their shots is successful). The risk and opportunity to exploit such a vulnerability is limited only by the scruples and morality of the participants in the game.

Such risks are normally accepted amongst small groups, either because participants trust that they can verify the winner's performance (e.g. through eyewitness confirmation from trustworthy bystanders), or simply through apathy (assuming the stakes for winning such a contest are low enough that participants simply do not care about the risk of someone cheating to win).

However, as the monetary stakes rise for such a contest (e.g. if the participant wagers a substantial sum of money, or if the prize for winning is substantial even if the golfer's personal wager is nominal), the possibility of dishonesty or cheating may discourage users from participating. For example, a “closest to the pin” or “longest drive” contest would be very unlikely to extend across multiple days (as the possibility of bad weather, or simply someone entering the course after dark and tampering with the location of the currently leading shot, would simply be too great). Accordingly, the informal nature of such activities has an inherent limit on the amounts and frequency of participation from players.

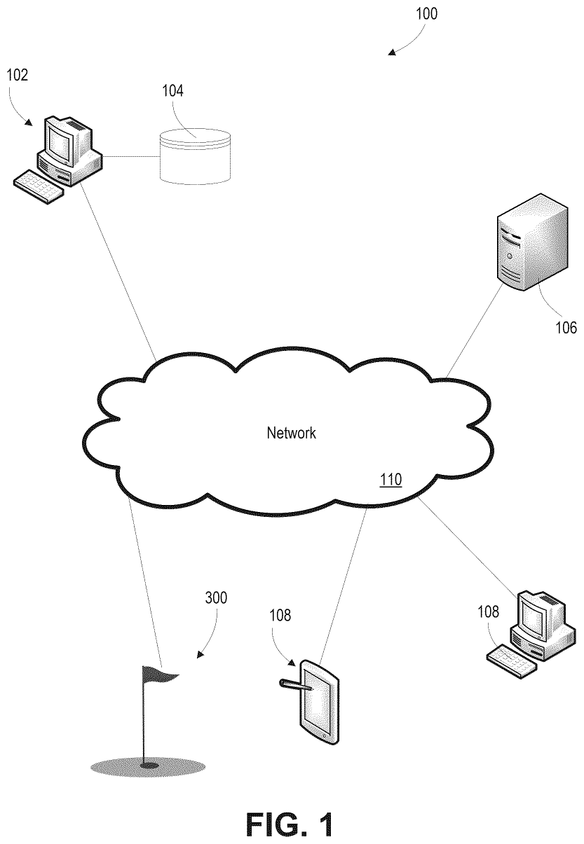

Various embodiments of the present invention may make use of interconnected computer networks and components. FIG. 1 is a diagram depicting components of an example computing system 100. Such a system may be suitable for implementing an electronic wagering system which offers both greater convenience and a greater degree of trustworthiness to participants, as well as the benefit of increased interest and participation for hosts (e.g. increased volume of golfers for golf courses incorporating system 100 into one or more holes).

Components of the computing system are interconnected to define a golf wagering (GW) system 100. As used herein, the term “golf wagering system” refers to a combination of hardware devices configured under control of software and interconnections between such devices and software. Such systems may be operated by one or more users, or operated autonomously or semi-autonomously once initialized.

As depicted, GW system 100 includes at least one server 102 with a data storage 104 such as a hard drive, array of hard drives, network-accessible storage, or the like; at least one web server 106, a plurality of client computing devices 108, and at least one flagstick device 300. Server 102, web server 106, client computing devices 108, and flagstick 300 are in communication by way of a network 110. More or fewer of each device are possible relative to the example configuration depicted in FIG. 1. Moreover, it is contemplated that in some embodiments, multiple components depicted in FIG. 1 may be embodied by the same hardware device (e.g. a client computing device 108 may also perform functions of a server 102, and the like). For example, embodiments are contemplated which include more than one smart flagstick 300 located at golf holes on the same golf course and/or at different golf courses.

Network 110 may include one or more local-area networks or wide-area networks, such as IPv4, IPv6, X.25, IPX compliant, or similar networks, including one or more wired or wireless access points. The networks may include one or more local-area networks (LANs) or wide-area networks (WANs), such as the internet. In some embodiments, the networks are connected with other communications networks, such as GSM/GPRS/3G/4G/LTE networks.

As shown, server 102 and web server 106 are separate machines, which may be at different physical or geographical locations. However, server 102 and web server 106 may alternatively be implemented in a single physical device.

As will be described in further detail, server 102 may be connected to a data storage 104. In some embodiments, web server 106 may host a website or application accessible by client computing devices 108 and/or flagstick 300. For example, an application locally installed on computing devices 108 may be configured to communicate with web server 106 to, for example, send and/or receive data, including one or more of wagers, notifications, advertisements, and the like. Web server 106 is further operable to exchange data with server 102 such that data associated with client computing devices 108 or flagstick 300 can be retrieved from server 102 and utilized in connection with wagering.

Server 102 and web server 106 may be based on Microsoft Windows, Linux, iOS, OSX, or other suitable operating systems. Client computing devices 108 may be, for example, personal computers, smartphones, tablet computers, flagstick 300, or the like, and may be based on any suitable operating system, such as Microsoft Windows, Apple OS X or iOS, Linux, Android, or the like.

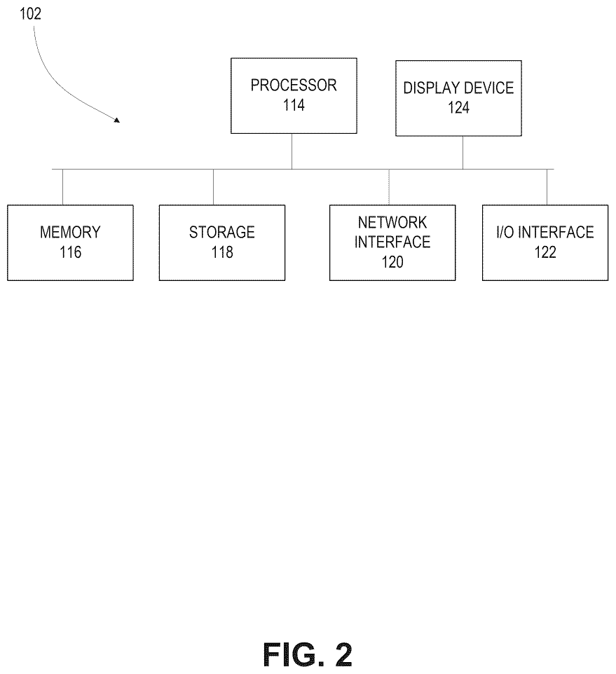

FIG. 2 is a block diagram depicting components of an example server 102, 106, smart flagstick 300, or client computing device 108. As depicted, each server 102, 106, client device 108, and smart flagstick 300 includes a processor 114, memory 116, persistent storage 118, network interface 120, and input/output interface 122. As noted above, FIG. 2 depicts an example embodiment of a server 102, and it is contemplated that in some embodiments, one or more components may be omitted from server 102 while still providing the functionality to perform various operations and aspects disclosed herein.

Processor 114 may be an Intel or AMD x86 or x64, PowerPC, ARM processor, or the like. Processor 114 may operate under the control of software loaded in memory 116. Network interface 120 connects server 102, 106, flagstick 300, and/or client computing device 108 to network 110. I/O interface 122 connects server 102, 106, or client computing device 108 to one or more storage devices (e.g. storage 104) and peripherals such as keyboards, mice, pointing devices, USB devices, disc drives, display devices 124, and the like.

In some embodiments, I/O interface 122 connects various sensors and other specialized hardware and software used in connection with the operation of smart flagstick 300 to processor 114 and/or to other computing devices 102, 106, 108. In some embodiments, I/O interface 122 may be used to connect smart flagstick 300 to other computing devices 102, 106, 108 and provide access to various sensors and other specialized hardware and software within smart flagstick 300.

In some embodiments, I/O interface 122 may be compatible with protocols such as WiFi (e.g. 802.11a/b/g/n/ac/ax), Bluetooth, and other wired and/or wireless communication protocols.

In some embodiments, sensors and other specialized hardware and/or software used in connection with smart flagstick 300 may include, for example, a sensor 310 for detecting the presence of a golf ball within a hole, camera(s) 306 configured to record video and/or audio footage of the area in the immediate vicinity of a golf hole, and/or power electronics configured to interface solar panels 308 with power source 302 to provide electrical power.

Software may be loaded onto server 102, 106, smart flagstick 300, or client computing device 108 from peripheral devices or from network 110. Such software (such as golf recording system 350) may be executed using processor 114.

For example, a software application (colloquially referred to as an “app”) may be executing on a client device (e.g. a smartphone of a user playing golf), and may be configured to communicate with server 102 and/or flag

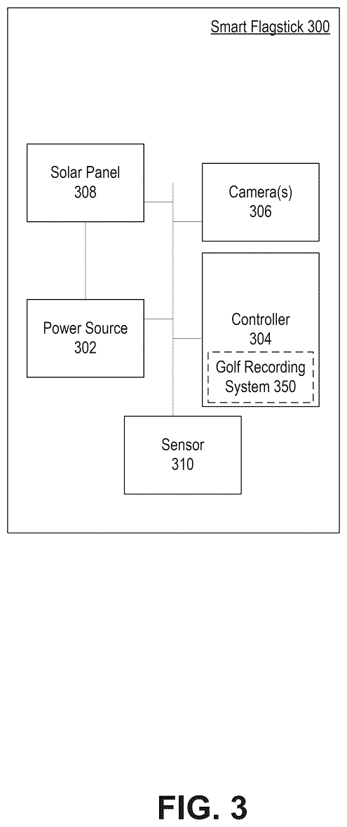

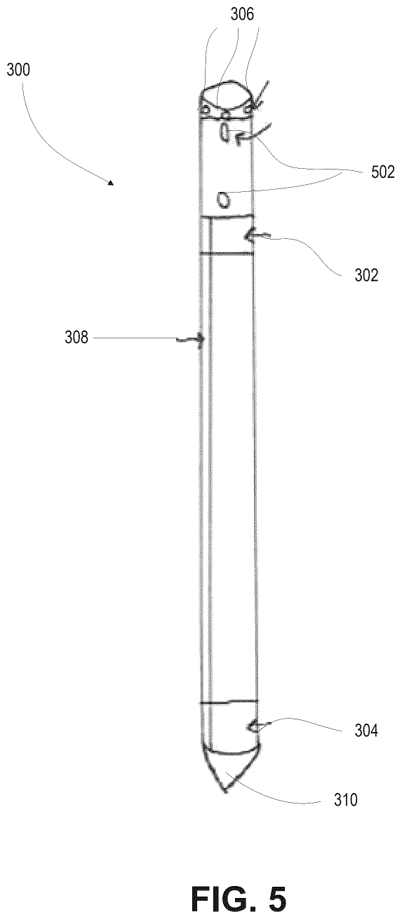

FIG. 3 is a block diagram depicting components of an example smart flagstick 300. As depicted, smart flagstick 300 may include power source 302, controller 304, one or more cameras 306, solar panel 308, and sensor 310. Controller 304 may be, for example, a computing device 102 as described above. FIG. 5 is an illustration of an example embodiment of smart flagstick 300.

Controller 304 may be configured to execute software, which may include an operating system and application software, such as a golf recording (GR) system 350. GR system 350 may be configured to interface with, for example, one or more systems or subsystems of smart flagstick 300, and to send control signals (e.g. to activate camera(s) 306 or upload recorded video to a data store (e.g. server 102 or data store 104)). In some embodiments, computing devices 108 may execute software configured to receive data and signals from smart flagstick 300 and GR system 350 (e.g. uploaded videos, acknowledgment signals, and the like) which may be used for wagering purposes (e.g. uploading a video of the vicinity of the hole on a golf hole to verify that a golfer has, for example, scored an ace (otherwise known as a hole-in-one)).

Power source 302 may provide electrical power to one or more of controller 304, camera(s) 306, and sensor 310. In some embodiments, power source 302 may comprise one or more batteries. In some embodiments, said batteries may be rechargeable batteries. Batteries may be, for example, housed in the shaft of smart flagstick 300. In some embodiments, power source 302 may include a wired connection to a power source (e.g. to an electrical outlet via an extension cord).

Solar panel 308 may include one of or an array of photovoltaic cells which are operable to receive and convert photons into electrical energy. Solar panel may be used to perform one or both of charging power source 302 (e.g. charging a rechargeable battery) and acting as power source 302. For example, a sufficient number of photovoltaic arrays may generate sufficient electrical energy to directly power components of smart flagstick 302 under certain conditions. In some embodiments, solar panels 308 may be positioned about the exterior of smart flagstick 300, and may be operable to receive sunlight throughout a day from different angles to charge power source 302. In some embodiments, solar panels may be positioned in an array which encircles the shaft of flagstick 300 (e.g. in a circular pattern, or octagonal, hexagonal, or any pattern which allows different incident angles of sunlight exposure to be captured throughout the day).

Smart flagstick 300 may include one or more cameras 306. In some embodiments, each camera 306 may be oriented so as to capture at least 180 degrees of the area in and around the hole on the golf green. Therefore, in a configuration with 2 cameras 306, a full field of view of the area of the golf green in and around the hole may be captured. In some embodiments, a single camera oriented towards the hole is contemplated. Camera 306 may be configured to capture video footage of golf balls landing on the golf green. In some embodiments, camera 306 may capture high definition video. In some embodiments, camera 306 may be configured to capture audio and/or video data.

GR system 350 may be configured to control whether camera(s) 306 are powered on. In some embodiments, GR system 350 may be configured to maintain camera(s) 306 in a dormant state when recording is not required. Maintaining hardware devices (such as cameras 306 and sensor 310) in a dormant state may be particularly beneficial in embodiments in which power source 302 includes battery power which may be limited or otherwise finite. GR system 350 may be further configured to send a control signal to cameras 306 to wake the cameras from the dormant state to an active state.

In some embodiments, GR system 350 may be configured to detect a voltage level of power source 302. For example, if the detected voltage level from power source 302 falls below a threshold voltage level, GR system 350 may transmit a notification to a third party (e.g. the operator of the golf course) that the battery level is getting low and that inspection and/or replacement of the batteries (or similar power source) is required.

Smart flagstick 300 may include sensor 310. In some embodiments, sensor 310 is configured to determine whether a ball (e.g. a golf ball) is present within the hole/cup on the golf green for which smart flagstick 300 is in use. In some embodiments, sensor 310 may be a pressure sensor configured to detect a change in pressure and/or weight within the cup. In some embodiments, sensor 310 may be a laser or light sensor positioned in the cup such that an expected time for reflected light to be detected at a sensor would indicate no ball present, and the presence of a ball in the cup may obstruct or otherwise change the path of the laser/light, thus indicating the presence of a ball. It will be appreciated that numerous types of sensors are possible for indicating the presence or absence of a ball in the cup. Moreover, in some embodiments, camera 306 alone may be sufficient to establish whether a golf ball has entered the hole or not. In some embodiments, sensor 310 may be toggled between an on/off state by controller 304 and GR system 350. Such a toggle state may allow for power to be conserved during periods of non-use. In some embodiments, the golf ball may have a tracking system integrated therein (e.g. GPS, RFID, and the like) which may allow for other hardware (e.g. smart flagstick 300) to detect the entrance of the ball into the golf hole.

As depicted in FIG. 5, the example embodiment of smart flagstick 300 may include 3 cameras 306 (though more or fewer than 3 is contemplated) located towards a top end of the flagstick 300. In some embodiments, cameras 306 may be located above the flag. Cavities 502 may allow for a flag to be inserted, to give smart flagstick 300 the appearance of a conventional flagstick. Solar panels 308 may line some or all of the exterior surface of flagstick 300. Power source 302 (e.g. batteries) may be located internally and in some embodiments may be stacked in series and run some or all of the length of the cylinder of flagstick 300. As depicted, controller 304 may be located towards the lower end of flagstick 300, near sensor 310. However, any suitable location for controller 304 is contemplated. Placing controller 304 internally within the shaft of flagstick 300 may provide additional protection to potential impacts with golf balls struck at speed.

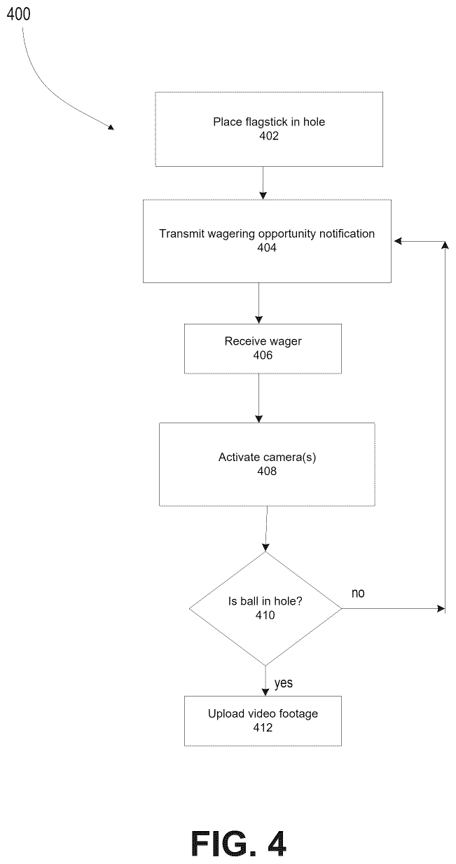

FIG. 4 is a flow chart depicting an example method 400 of recording an activity. At 402, a flagstick (e.g. smart flagstick 300) is placed in a hole on a golf green. In some embodiments, the hole is a par 3. Smart flagstick may be activated by, for example, toggling an on/off button. In some embodiments, smart flagstick 300 may require calibration to confirm that cameras 306 are oriented correctly to capture footage of the golf green.

At block 404, a notification is transmitted to notify a user of a wagering opportunity. In some embodiments, the notification is transmitted from a remote server 102. In some embodiments, a golfer having a GR client application installed on their smartphone 108 may receive the notification that they may place a wager on the outcome of the hole for in which smart flagstick 300 is placed. In some embodiments, the notification may be transmitted based on the location of the golfer's smartphone 108. For example, server 102 may maintain a database containing a listing of all active smart flagsticks 300 together with corresponding location. The GR client application on the golfer's smartphone 108 may monitor the location of the smartphone via the GPS unit in the golfer's smartphone. In some embodiments, when the golfer's smartphone 108 is determined to be within a threshold distance of smart flagstick 300, a notification may be sent informing the user of the possibility to wager on the tee shot of the par 3. In other embodiments, smart flagstick 300 may emit a beacon signal operable to be received by nearby mobile communication devices. A mobile device with the GR client application installed may be operable to receive and decode the beacon signal to determine that smart flagstick 300 is in the vicinity of smartphone 108. In some embodiments, a golfer may manually initiate use of a GR client application without receiving any notification. For example, a user may navigate to the GR client application on their mobile device and manually select one or more of the course and hole at which they are located, and place wagers without having received any notification of the availability of such wagers. In some embodiments, signage may be placed at various locations around a golf course to notify the user of the availability of such wagering systems.

In some embodiments, the golfer may place a wager on the outcome of their tee shot at the par 3 golf hole. For example, a golfer may place a bet that their tee shot will result in a hole-in-one. The quantum of the amount wagered may be any appropriate amount. In some embodiments, the wager may be relatively small (e.g. between $1 to $5), so as to encourage golfers to participate. In other embodiments, users may wager larger amounts of money.

In some embodiments, a wager may be placed electronically (e.g. by charging the golfer's credit card, or any other suitable form of electronic payment transfer). The use of electronic payments may make a golfer more likely to participate, as the use of physical currency may be cumbersome and golfers may not have the exact amount of cash on hand to place a wager. When a user places a wager, the wager may be stored in a database maintained by, for example, server 102.

In some embodiments, the wager may be placed in a pool of wagers made by the golfer as well as other golfers. In some embodiments, the golfer will forfeit their wager if they do not hit a hole-in-one. In some embodiments, the golfer may win the prize pool or a portion of the prize pool if their tee shot results in a hole-in-one. It will be appreciated that numerous options are available for the structure in which wagers are allocated and distributed. For example, the golf course may receive a share (or “cut”) of each wager made in exchange for placing the smart flagstick 300 on their golf course. In other examples, the golf course may receive a percentage of the outstanding prize pool at predetermined time intervals (e.g. a monthly payment of 1% of the total outstanding prize pool).

At block 406, the golfer who received the notification may place a wager. It should be noted that in some embodiments, a notification need not be received and the golfer may manually enter a wager for the hole (e.g. by noticing signage near the tee box, opening the application on their smartphone 108, and placing a wager).

At block 408, the receipt of the wager may cause server 102 to transmit an instruction or command to controller 304 of smart flagstick 300 to activate cameras 306 and/or sensor 310. In this manner, the power consumed by cameras 306 and/or sensor 310 may be kept to a minimum by only activating cameras 306 to record when a user has placed a bet into the system. This also reduces the likelihood of privacy concerns among non-participants, as cameras 306 would not be recording unnecessarily.

In some embodiments, the placing of a wager by the golfer may cause the cameras to activate for a set period of time (e.g. 30 seconds, 1 minute, or any suitable amount of time for allowing the golfer to set up, prepare for, and take their tee shot). The golfer who placed the wager may then take their tee shot and attempt to hit a hole-in-one. In some embodiments, the golfer may take a photo of the ball they are using when taking their tee shot. In some embodiments, this photo may be uploaded to server 102 and associated with the video taken by cameras 306. This may be useful subsequently if there is a dispute that the ball which entered the hole was not the same ball used for the tee shot, as the uploaded video footage of the ball rolling into the hole may be compared to the uploaded photo of the ball taken before the tee shot. In some embodiments, audio data from the uploaded video may be assessed (e.g. for the presence of the sound of more than one ball strike) to confirm that only one tee shot was taken by the better.

In some embodiments, controller 304 may execute a machine vision algorithm in which the presence of a moving golf ball on the green detected by cameras 306 may trigger a the camera to continue recording until such a time as when the golf ball is stationary. In some embodiments, the golfer may manually transmit a command that they have taken their shot, thereby allowing the cameras to stop recording (for example, in cases where the tee shot does not make the green and cannot be detected by cameras 306).

At 410, the system determines whether the golf ball is in the hole. If not, the system returns to block 404, where a subsequent notification may be sent to a different user. In some embodiments, the same golfer may not be allowed to place multiple wagers on the same hole. In other words, the golfer has one attempt at the tee shot and cannot repeatedly take tee shots. In other embodiments, the golfer may be allowed to continue placing successive wagers and taking successive tee shot attempts.

The presence or absence of the ball may be determined, for example, by a sensor 310. As noted above, the sensor can be one of numerous suitable types of sensors for detecting the presence of an object (e.g. by pressure/weight, optically, by the sound of the ball making contact with the cup when the ball falls in, or the like).

If the ball is in the hole, the video footage of the tee shot will be uploaded to server 102 at block 412. In some embodiments, detection of the presence of the ball in the hole may cause controller 304 to automatically upload the video and/or audio footage of the tee shot to server 102 for verification.

Once verified that the hole-in-one shot was legitimate, server 102 may initiate a transfer of some or all of the accumulated prize pool to the golfer who struck the hole-in-one ball. Such a transfer may occur through any suitable electronic payment system. In some embodiments, the better who hits a hole-in-one may receive all of the accumulated prize pool (for example, the prize pool may grow as other better unsuccessfully bet on striking a hole-in-one). In some embodiments, the prize for a hole-in-one may be a portion of the betting pool, or a fixed amount. The use of a fixed amount as a prize may be useful in allowing the betting pool to accumulate to a sufficiently high monetary amount so as to be self-sustaining in the event of multiple hole-in-one shots in relatively quick succession (as opposed to an outcome in which two holes-in-one are hit back to back, and the second winner receives a relatively small prize given that the pool has been liquidated after the first winner). It will be appreciated that any such variation in the allocation of the betting pool to the winner would operate using the same principles described herein and is a manner of choosing the desired quantum or payout system to the winner.

In some embodiments, the better may have the option of choosing the desired prize when placing their bet (for example, a better might wager $20 for the chance at winning a much greater prize pool, or wager $3 for the chance at winning a fixed $500 for striking a hole-in-one).

In some embodiments, the betting pool may be limited to a particular golf hole on a particular golf course. In some embodiments, the systems described herein may be implemented on multiple holes at the same golf course (in which case it is contemplated that the betting pool could apply across all holes enabled by smart flagstick 300, or each hole could have its own separate prize money pool). Such variances would be left to the discretion of the golf course operator and the betting system operator.

In some embodiments, smart flagsticks 300 may be used across multiple holes at multiple course, whether in the same city, state/province, country, or worldwide. As such, it will be appreciated that scaling the disclosed system 100 across multiple holes is a matter of connecting multiple smart flagsticks 300 to network 110 such that bets and wager placed by users on their smartphone devices 108 can be transmitted to server 102 and video recorded by smart flagstick 300 can be uploaded to server 102 for verification in the event of a hole-in-one.

Some embodiments of the present invention may allow golfers from around the world to connect and wager money on golf shot or other sporting outcome. Moreover, the use of smart flagstick 300 would allow for betters to have greater trust in the system, as there would be some reassurance that a golfer striking a hole-in-one on a different course to claim a large prize would have done so legitimately. In some embodiments, video footage of a winning shot by a better may be accessible via web server 106 so as to allow other participants to view the video footage of the successful hole-in-one attempt, which further enhances the trustworthiness of the systems and methods described herein.

Some embodiments of the present invention allow for smart flagstick 300 to be placed on a golf green without raising privacy concerns for other golfers who are not participating in better activities. For example, since cameras 306 can be configured to not be activated until a bet is received for the particular hole at which smart flagstick 300 is placed, non-participants will not be subjected to having their golf shots recorded. Moreover, the use of smart flagstick 300 is relatively seamless (as golf courses have legacy flagsticks in every hole regardless), and the addition of cameras to different areas of the hole (e.g. the tee box or the surroundings) may be unsightly and aesthetically unpleasing relative to a camera integrated into the flagstick. In addition, the use of batteries and solar panels in some embodiments may obviate the need for cumbersome power cords and extension cords being used to power cameras.

It should be noted that although this disclosure makes frequent reference to golf, holes-in-one, smart flagsticks, and other golf-related concepts, it is contemplated that embodiments disclosed herein have application with other sporting activities and other events. For example, concepts described herein may be used in connection with a basketball court system (e.g. on a cruise ship or at a resort) which uses an automated solar-charged power source to activate a camera (e.g. inside a backboard or near a basketball net) to allow players to place live wagers on a basketball contest (e.g. “21”, 3-point shooting contests, or the like).

Likewise, some embodiments described herein may be applicable to other types of activities within a golfing event. For example, systems and methods described herein may be used to conduct a “closest to the pin” type wager, in which multiple golfers attempt a shot expected to land on the putting green, and the systems may be operable to determine which of a plurality of balls located on the putting green is the closest. In other embodiments, a user may be able to wager that their shot lands within a threshold distance of the golf hole. For example, a plurality of concentric rings may be defined around the golf hole at various distances (e.g. within 1 foot, between 1 and 2 feet, between 3 and 5 feet, between 5 and 10 feet, or any range as desired). In this manner, and user may have the option of wagering as to whether they can hit a hole in one, but also to wager (with different odds and payouts) whether their tee shot comes to a stop within a threshold distance of the hole. This may be enabled in a number of ways, such as calibrating the GR system and cameras 306 on smart flagstick to record footage of various distances of from a hole and generate a machine-learning or artificial intelligence model, which can then be used as a classifier for determining whether a ball is inside of or outside of a distance to the hole.

Of course, the above-described embodiments are intended to be illustrative only and in no way limiting. The described embodiments are susceptible to many modifications of form, arrangement of parts, details, and order of operation. For example, cameras 306 may be positioned in other locations than smart flagstick 300, or in other locations in addition to cameras 306 which are disposed on or in smart flagstick 300. Cameras 306 may be located, for example, at one or more of the following locations, to name but a few: within an unmanned aerial vehicle (e.g. a drone) located above the golf hole, so as to obtain a “bird's eye view”, behind the putting green, next to the putting green, behind the tee box for the golf hole, next to or adjacent to a tee box, within a ball washing device in the vicinity of the golf hole, within a mobile electronic device of the golfer teeing off (or a mobile electronic device of another user located near the golf hole), in a series of cameras located between the putting green and the whole video recording the shot (multiple cameras, or one wide-lens angle camera), using satellite imagery, contained within wearable electronics (e.g. smart glasses and other wearables), at a high elevation on a pole or a plurality of poles (which could, in some embodiments, obtain recordings of more than one hole and/or all holes at a golf course), suspended on a wire/cable strung across the hole, and the like.

The invention is intended to encompass all such modifications within its scope, as defined by the claims.

What is claimed is:

1. A system for recording a golf activity, the system comprising:
a flagstick device placed in a golf hole;
a mobile device associated with a golfer;
said system configured to:
receive a wager from said mobile device relating to said golf hole;
activating one or more cameras;
recording a video with said cameras of an area in a vicinity of said golf hole;
determining whether a ball is inside said golf hole.

2. The system of claim 1, further comprising transferring a reward to said golfer when said ball is determined to have entered said golf hole in a single shot.

3. The system of claim 1, wherein said one or more cameras are disposed on said flagstick device.

4. The system of claim 1, wherein said flagstick device further comprises a photovoltaic device configured to charge a power source connected to said one or more cameras.

5. The system of claim 1, wherein said flagstick device further comprises a sensing device for detecting a presence of said ball inside said golf hole.

6. The system of claim 1, further comprising a server, and wherein said system is configured to transmit said video to said server when said ball is determined to be inside said golf hole.

7. The system of claim 1, wherein said system is configured to detect that said mobile device is within a threshold distance of said golf hole and, responsive to detecting that said mobile device is within a threshold distance of said golf hole, transmit a notification to said mobile device.

8. The system of claim 7, wherein said system is configured to detect that said mobile device is located at a point of interest within said threshold distance of said golf hole.

9. The system of claim 8, wherein said point of interest is a tee box of said golf hole.

10. The system of claim 1, wherein said one or more cameras are positioned on, within, or in proximity of one or more of an unmanned aerial vehicle in a vicinity of said golf hole, one or more satellites, smart glasses, wearable devices, a putting green of said golf hole, a tee box of said golf hole, a ball washer in the vicinity of said golf hole, and one or more tee box markers of said golf hole.

11. The system of claim 1, wherein at least one of said one or more cameras is integrated into said mobile device.

12. The system of claim 1, wherein said ball comprises a location tracking device.

13. The system of claim 1, wherein said one or more cameras are positioned at a height above said golf hole.

14. The system of claim 1, wherein said system is configured to, when determined that said ball is outside of said golf hole, estimate a distance of said ball to said hole.

15. The system of claim 14, further comprising another ball, and wherein said system is configured to determine which of said ball and said another ball is closer to said golf hole.

16. The system of claim 1, wherein said one or more cameras are activated in response to receiving said wager.

17. A method for recording a golf activity, the method comprising:
receiving, from a mobile device, a wager relating to a golf hole;
responsive to receiving said wager, activating one or more cameras;
recording a video with said one or more cameras of an area in a vicinity of said golf hole; and
detecting whether a ball is inside said golf hole.

18. The method of claim 17, further comprising transferring a reward to an account associated with said mobile device when said ball is determined to have entered said golf hole in a single shot.

19. The method of claim 17, further comprising placing a smart flagstick in said golf hole, wherein said smart flagstick comprises said one or more cameras.

20. A system for recording a golf activity, the system comprising:
a server;
a flagstick device comprising one or more cameras, said flagstick placed in a golf hole;
said system configured to:
activate said one or more cameras;
record a video with said cameras of an area in a vicinity of said golf hole; and
transmit said video to said server.
